(19) United States
(12) Patent Application Publication
(10) Pub. No.: US 2007/0169419 A1
(43) Pub. Date: Jul. 26, 2007

(54) Sonochemical leaching of polycrystalline diamond

(75) Inventors: Ken Davis, Ruidoso, NM (US); Ryan Clint Frazier, Midland, TX (US); John G. Fischer, Irving, TX (US)

Correspondence Address: STORM LLP, BANK OF AMERICA PLAZA, 901 MAIN STREET, SUITE 7100, DALLAS, TX, 75202, US

(73) Assignee: Ulterra Drilling Technologies, Inc.

(21) Appl. No.: 11/340,241

(22) Filed: Jan. 26, 2006

(51) Int. Cl. B06B 1/00; B24D 18/00

(52) U.S. Cl. 51/293; 422/127

(57) ABSTRACT

A method for accelerated leaching of binder-catalyst material from the polycrystalline diamond structure of a PDC is disclosed. The PDC is sonochemically leached. Also disclosed are fixture, equipment and a system for sonochemically leaching the polycrystalline diamond structure of a PDC.

### TECHNICAL FIELD OF INVENTION

The present invention relates to the manufacture of polycrystalline diamond cutting tools, and in particular, cutting tools which have had a portion or all of the binder material leached from the diamond.

### BACKGROUND OF THE INVENTION

In the exploration of oil, gas, and geothermal energy, drilling operations are used to create boreholes, or wells, in the earth. These operations normally employ rotary and percussion drilling techniques. In rotary drilling, the borehole is created by rotating a tubular drill string with a drill bit secured to its lower end. As the drill bit deepens the hole, tubular segments are added to the top of the drill string. While drilling, a drilling fluid is continually pumped into the drilling string from surface pumping equipment. The drilling fluid is transported through the center of the hollow drill string and into the drill bit. The drilling fluid exits the drill bit at an increased velocity through one or more nozzles in the drill bit. The drilling fluid then returns to the surface by traveling up the annular space between the borehole and the outside of the drill string. The drilling fluid carries rock cuttings out of the borehole and also serves to cool and lubricate the drill bit.

One type of rotary rock drill is a drag bit or fixed cutter bit. Early designs for fixed cutter bits included hard facing applied to steel cutting edges. Modern designs for drag bits have extremely hard cutting elements, such as natural or synthetic diamonds, mounted to a bit body. The synthetic diamonds are generally known as polycrystalline diamond compact cutters (PDCs). As the drag bit is rotated, the PDC cutters scrape against the bottom and sides of the borehole to cut away rock.

The polycrystalline diamond element portion of the PDC cutters is also available in forms in which some or all of their binder material are leached from between the diamond crystals. These cutters are known as thermally stable polycrystalline diamond cutters (hereinafter collectively referred to as “TSD cutters”). The PDC cutters and TSD cutters may be used in the manufacture of PDC bits.

Polycrystalline diamond elements are most commonly formed by sintering diamond powder with a binder-catalyzing material in a high-pressure, high-temperature press. Typically, in the manufacture of polycrystalline diamond elements, diamond powder is applied to the surface of a preformed tungsten carbide substrate incorporating a cobalt binder-catalyst. The assembly is then subjected to very high temperature and pressure in the press. During the process, the cobalt migrates from the substrate into the diamond layer and acts as a binder-catalyzing material, causing the diamond particles to bond to one another with diamond-to-diamond bonding. The binder-catalyst also causes the diamond layer to bond to the substrate by bonding, for example, with the cobalt in the tungsten carbide substrate.

The completed polycrystalline diamond element comprises a matrix of connected diamond crystals bonded together with interstices comprised of the binder-catalyzing material. Typically, diamond crystals may constitute 85% to 95% by volume of the PDC, and the binder-catalyzing material may constitute the remaining 5% to 15%. Due to significantly different thermal expansion rates of the binder-catalyzing material and the diamond matrix, the PDC is susceptible to thermal degradation. The binder-catalyst expands at a substantially greater rate. As the binder-catalyst expands, it creates pressure on the diamond-to-diamond bonds, expanding and weakening them. Combined with the external forces acting on the PDC, they begin to break, causing accelerated degradation of the PDC.

In addition to thermal cracking, the diamond may graphitize in the presence of the binder-catalyst as temperature increases, further accelerating degradation and reducing the life of the PDC. The combined causes of thermal degradation greatly accelerate the destruction of the polycrystalline diamond when the temperature of the diamond exceeds 700° centigrade.

As stated, cobalt is the most commonly used binder-catalyzing material. Other materials, including any of Group VIII elements, may be employed.

To reduce thermal degradation, various post-sintering attempts to remove the binder-catalyst from the PDC have been developed. The resulting product is a PDC with all or some of the binder-catalyst removed from the interstices of the bonded diamond crystals. Typically, the binder-catalyst is removed by exposing the PDC to a highly corrosive substance, such as acid, or by an electrolytic process, or a combination thereof. As used herein, “corrosive solution” refers to a solution that is corrosive to the binder-catalyst, and not to diamond.

It is desirable to remove the binder-catalyst only from the working, or “cutting” surface of the PDC. Therefore, it is necessary to shield the remainder of the PDC from exposure to the corrosive substance.

These products are commonly referred to as “thermally stable” polycrystalline diamond compacts or “TSD” elements. A number of prior patents address leaching of polycrystalline diamond.

U.S. Pat. No. 3,745,623, issued to Wentorf, Jr. et al., discloses a cutting tool formed of diamond particles subjected to a superpressure process in which the diamond particles are bonded to a sintered carbide substrate. A fragment of a cutting tool was leached in HF, HCL and HNO3, which resulted in removal of residual metal, although some magnetic metal remained in the compact (Column 8, lines 33-55).

U.S. Pat. Nos. 4,224,380 and 4,288,248, issued to Bovenkerk et al., are related patents disclosing similar inventions with variations in the claims. Both disclose treatment of a diamond compact to remove substantially all infiltrated material in order to improve the thermal stability of the PDC. In Example IV, a carbide substrate was masked with epoxy and leached in 3HCL:1HNO3 until a “substantial portion of the metallic phase” was removed. Other examples use HF, HCL and HNO3 in various combinations and for varying times to leach material from the diamond. The precise degree of removal of the metallic phase is unclear, but seems to vary from 0.2 weight percent to 0.15 weight percent remaining in the diamond.

U.S. Pat. No. 4,572,722, issued to Dyer, discloses a diamond abrasive compact that is leached in HF and HCL (Example I) or Aqua Regia (3HCL:1HNO3, Example II) to remove 99 weight percent of the original cobalt in the diamond material.

U.S. Pat. No. 4,518,659, issued to Gigl et al., discloses the “sweep through” method of making polycrystalline diamond compacts that is improved by “sweeping through” with an intermediate metal having a melting point lower than the catalyst metal. The resulting compacts may be made “thermally stable” by leaching first in 1HF:1HNO3 and second in Aqua Regia in accordance with the '380 patent referenced above.

U.S. Pat. No. 4,636,253, issued to Nakai, et al., discloses a diamond sintered body using cobalt as a catalyst. The body is leached with Aqua Regia so that the pore volume in the sintered body is less than 10%. Only the diamond table or layer is dipped in the Aqua Regia. In Example 9, the body was only “partially” leached, leaving 0.8 volume percent cobalt and 3.06 volume percent pores.

U.S. Pat. No. 4,931,068, issued to Dismukes, et al., discloses a “fully dense” diamond body that is heated to 155° C. for 60 minutes to rearrange and remove dislocations. The resulting body is leached free of cobalt impurities using HCl and water, and 3HCl:1HNO3.

U.S. Pat. No. 4,943,488, issued to Sung et al., discloses a method for securing TSDs to carbide substrates, either singly or in “mosaics.” The process begins with leached TSDs, but no leaching details are supplied.

U.S. Pat. No. 5,068,148, issued to Nakahara et al., discloses a diamond coating on a substrate. The coating is etched for 5 minutes in nitric acid to remove cobalt from outermost portions of the coating.

U.S. Pat. No. 5,127,923, issued to Bunting et al., discloses a sintered diamond compact that is leached with Aqua Regia for 7 days and resintered with a non-catalyst sintering aid material (Ni—Fe, for example).

U.S. Pat. No. 6,344,149, issued to Oles, discloses a polycrystalline diamond member that is etched with nitric acid to produce an exterior region that is essentially free of the catalyst (typically cobalt), while the interior region has catalyst in conventional quantities. The exterior region is covered with a CVD-applied hard material, such as diamond.

U.S. Pat. No. 6,447,560 issued to Jensen et al., discloses a method of forming superhard (PDC or CBN) cutting tools having integral chip-breaking features or surfaces. In the background, it is noted that catalyst may be leached from the superhard material, but no leaching process or step is disclosed. It also states that maintaining a uniform distribution of cobalt throughout the diamond particles improves durability and temperature tolerance.

U.S. Pat. No. 6,601,662, issued to Matthias et al., discloses polycrystalline diamond or diamond-like cutters for rock bits in which one region is leached of catalyst and another region is not. This is consistent in its disclosure with the Griffin patents discussed below.

U.S. Pat. No. 6,410,085, issued to Griffin et al., discloses a superhard polycrystalline diamond or diamond-like element that is leached “by an appropriate treatment of the component to remove the catalyzing material from the interstices located within a volume close to a surface which, in the final product, will be a working surface thereof.” The diamond table then is coated with a metallic or other conductive material to permit electronic discharge machining (EDM) of the element.

U.S. Pat. Nos. 6,562,462, 6,544,308, 6,585,064, 6,589,640, 6,592,985, 6,739,214, 6,749,033, 6,797,326, and U.S. Publication Nos. 2003/0235691, 2004/0105806 and 2004/0115435, issued to Griffin et al., are commonly owned and related as continuations and divisions of one another. The disclosed structure is a diamond or diamond-like structure for a rock bit insert or cutting element in which a portion of the element retains catalyzing material, and the portion adjacent to the cutting surface is substantially free of the catalyzing material. While the leaching process is not detailed, the leached cutting surface is claimed in combination with other features, such as diamond particle size, insert geometry, and the like.

A principal disadvantage of the prior-art methods of leaching binder-catalyst from PDC elements is that they all rely on a slow chemical process in which the binder-catalyst is slowly dissolved by an acidic reagent in a static bath. A second disadvantage of this process is it produces a relatively uneven plane of transition between the binder-catalyst free zone of the diamond structure and the binder-catalyst filled zone of the diamond structure. The uneven and unpredictable transition between these zones can yield areas of the diamond structure that are particularly susceptible to thermal degradation. A third disadvantage of this process is that it generates a substantial quantity of hazardous waste.

Therefore, there is a need to develop an improved method and apparatus for leaching binder-catalyst from sintered PDC elements that is faster, and that produces a more uniform transition between the binder-catalyst free zone of the diamond structure and the binder-catalyst filled zone of the diamond structure.

### SUMMARY OF THE INVENTION

A primary advantage of the present invention is that it accelerates the known methods of chemical leaching of binder-catalysts from sintered polycrystalline diamonds (PDCs). Another advantage of the present invention is that it produces a more uniform transition between the binder-catalyst free zone of the diamond structure and the binder-catalyst filled zone of the diamond structure. Another advantage of the present invention is that it reduces the generation of hazardous waste.

As referred to hereinabove, the “present invention” refers to one or more embodiments of the present invention which may or may not be claimed, and such references are not intended to limit the language of the claims, or to be used to construe the claims in a limiting manner.

The present invention relates to a method of leaching a portion or all of the binder-catalyst of a PDC from between the bonded diamond crystals by:

1. shielding the portion of the PDC not to be leached;

2. immersing the shielded PDC in corrosive solution; and

3. inducing sonic energy at the interface between the PDC and the corrosive solution.

In another preferred embodiment, the immersed and shielded PDC is substantially isolated from other immersed and shielded PDCs in the corrosive solution.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a PDC element in which the binder-catalyst remains present.

FIG. 2 is an isometric view of a TSD element in which the binder-catalyst has been leached from a large portion of the polycrystalline structure.

FIG. 3 is an isometric view of a leaching fixture in accordance with a preferred embodiment of the present invention.

FIG. 4 is a bottom view of a leaching fixture in accordance with a preferred embodiment of the present invention.

FIG. 5 is a top view of a shielding fixture for a PDC cutter for leaching in accordance with a preferred embodiment of the present invention.

FIG. 6 is a side cross-sectional view of the fixture and PDC combined.

FIG. 7 is a side cross-sectional view of a system for sonochemical leaching in accordance with a preferred embodiment of the present invention.

FIG. 8 is a top view of a leaching tray in accordance with a preferred embodiment of the present invention.

FIG. 9 is a side cross-sectional view of the leaching tray of FIG. 8, shown with PDCs located in the sockets formed in the tray.

FIG. 10 is side cross-sectional view of an alternative embodiment of the leaching tray of FIG. 9, in which the sockets receive fixtures shielding the PDCs.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

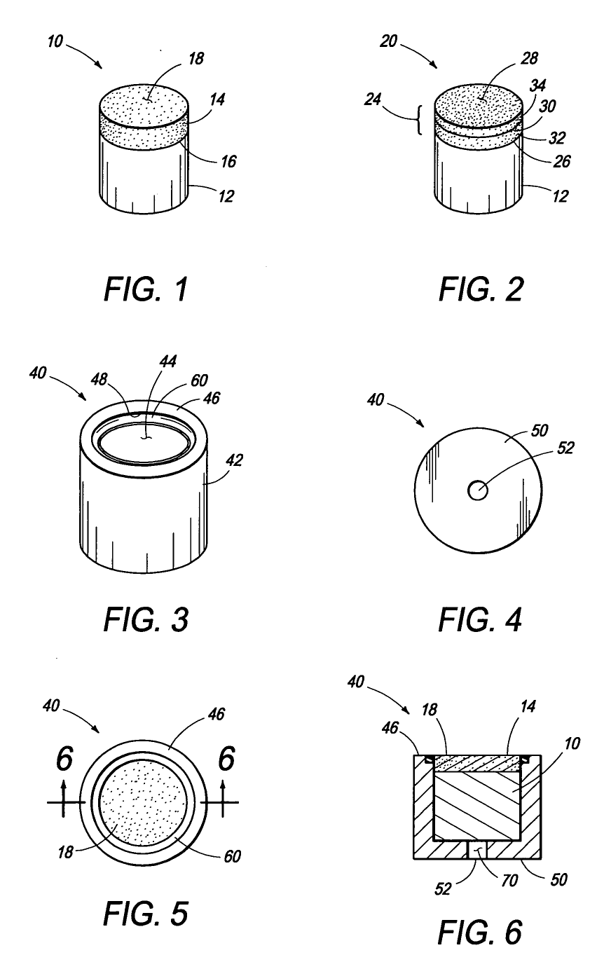

FIG. 1 is an isometric view of a PDC element 10. PDC 10 comprises a substrate portion 12. Substrate portion 12 is typically a cylindrical post of sintered tungsten carbide. A cylindrical polycrystalline diamond wafer 14 is bonded to substrate portion 12 at an interface 16. A cutting surface 18 is exposed opposite interface 16 as a working surface. Wafer 14 is typically comprised of between 85% to 95% polycrystalline diamond by volume, and between 5% to 15% binder-catalyzing material by volume. Typically, the binder-catalyzing material is cobalt.

FIG. 2 is an isometric view of an example TSD element 20. TSD 20 comprises a substrate portion 12. Substrate portion 12 is typically a cylindrical post of sintered tungsten carbide. A cylindrical polycrystalline diamond wafer 24 is bonded to substrate portion 12 at an interface 26. A cutting surface 28 is exposed opposite interface 26 as a working surface. Wafer 24 is divided into two general portions at an interface 30. A binder-catalyst filled portion 32 forms the lower portion, bonded to substrate portion 12. A binder-catalyst leached portion 34 forms the upper portion, adjoined to the filled portion 32 at interface 30. Leached portion 34 provides TSD element 20 with a thermally stable cutting surface 28. Filled portion 32 of wafer 24 is typically comprised of between 85% to 95% polycrystalline diamond by volume, and between 5% to 15% binder-catalyzing material by volume. Leached portion 34 is typically comprised of between 85% to 95% polycrystalline diamond by volume, and has no binder-catalyzing material. The remaining 5% to 15% of the volume is void.

FIG. 3 is an isometric view of a shielding fixture 40. In the preferred embodiment, fixture 40 has a body 42. Fixture 40 has a hollow cylindrical center 44 for receiving PDC element 10. Fixture 40 has a topside 46. In a preferred embodiment, a counterbore 48 is located on top side 46, coaxially with center 44, for receiving a seal 60. In the preferred embodiment, seal 60 is an acid-resistant, elastomeric o-ring.

FIG. 4 is a bottom view of a leaching fixture 40. Fixture 40 has a base 50. A small relief 52 provides communication between internal hollow center 44 and the exterior of fixture 40.

FIG. 5 is a top view of fixture 40 illustrating PDC 10 located in center 44. Seal 60 forms a compressive engagement with diamond wafer 14 such that cutter surface 18 comprises the substantially exposed portion of PDC 10 while the remainder of PDC 10 is shielded by fixture 40. In an alternative embodiment (not illustrated), PDC 10 is located in center 44 of body 42 in interference-fit relationship.

FIG. 6 is a side cross-sectional view of fixture 40 containing PDC 10, as illustrated in FIG. 5. In the preferred embodiment disclosed in this view, the interior of fixture 40 has been coated with a sealant 70. As PDC 10 is pressed into fixture 40, sealant 70 fills relief 52. In the preferred embodiment, sealant 70 is acid-resistant grease. When PDC 10 is fully located in fixture 40, cutting surface 18 is even with, or protruding slightly above, topside 46 of fixture 40. Relief 52 provides a means for removing PDC 10 from fixture 40 after leaching.

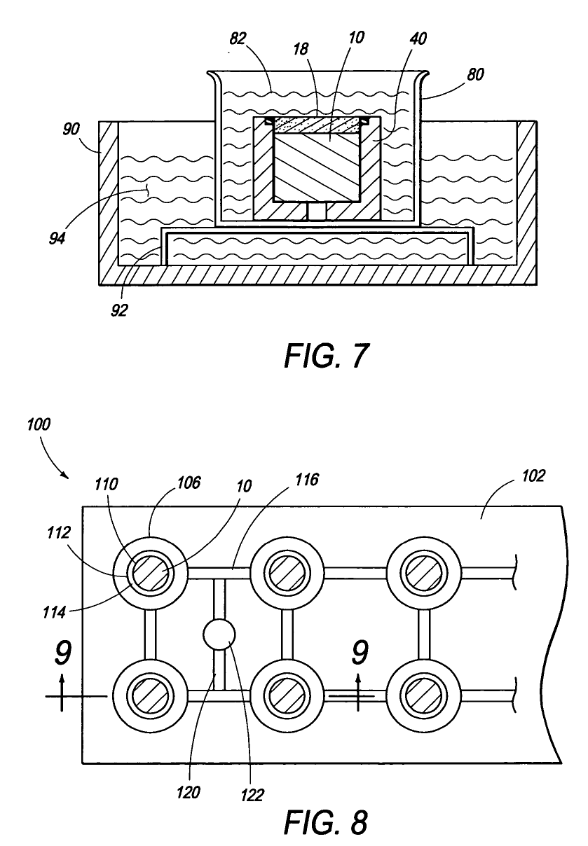

FIG. 7 is a side cross-sectional view of a system for sonochemical leaching in accordance with a preferred embodiment of the present invention. PDC 10 is located in fixture 40. Fixture 40 is located in a beaker 80. Beaker 80 is filled with a corrosive solution 82. In the preferred embodiment, corrosive solution 82 is an acid mixture such as Aqua Regia. Sonic vessel 90 is a vessel having transducers attached to provide the sonic energy to a liquid 94 contained therein. In the preferred embodiment, sonic vessel 90 is an ultrasonic vessel. A stand 92 may be provided within sonic vessel 90. Sonic vessel 90 is partially filled with inert liquid 94 such as water. Beaker 80 containing corrosive solution 82, fixture 40, and PDC 10, is located on stand 92 for processing.

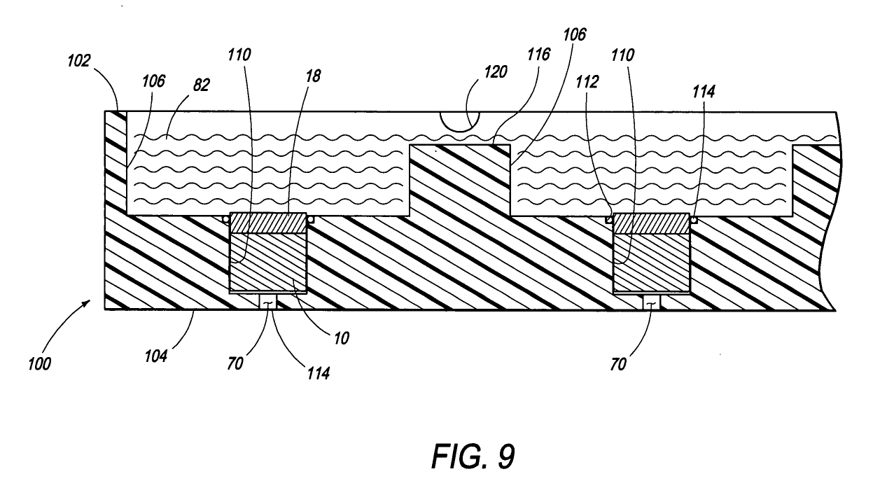

FIG. 8 is a top view of a leaching tray 100 in accordance with a preferred embodiment of the present invention. Tray 100 has a top 102 and an opposite bottom 104 (shown in FIG. 9). Tray 100 has a plurality of spaced apart reservoirs 106 which are substantially isolated from each other. A socket 110 for receiving a PDC 10 is located at the bottom of each reservoir 106. In a preferred embodiment, a counterbore 112 is located at the top of each socket 110. An acid-resistant o-ring 114 is located in each counterbore 112. In another preferred embodiment, a plurality of equalizing channels 116 interconnects reservoirs 106. In another preferred embodiment (not shown), a plurality of overflow channels 120 provides a limit to the volume of corrosive solution 82 in each reservoir 106. Overflow channels 120 may be directed to an overflow reservoir 122.

FIG. 9 is a side cross-sectional view of leaching tray 100 of FIG. 8, shown with PDCs 10 located in sockets 110. As seen in this view, excess corrosive solution 82 is equalized between reservoirs 106 by free flow across channels 116. A small relief 118 provides communication between each socket 110 and tray bottom 104. In the preferred embodiment disclosed in this view, the socket has been coated with a sealant 70. As PDC 10 is pressed into socket 110, sealant 70 fills relief 118. In the preferred embodiment, sealant 70 is acid-resistant grease. When PDC 10 is fully located in socket 110, cutting surface 18 is even with, or protruding slightly above, the bottom of reservoir 106. Relief 118 provides a means for removing PDC 10 from the socket after leaching.

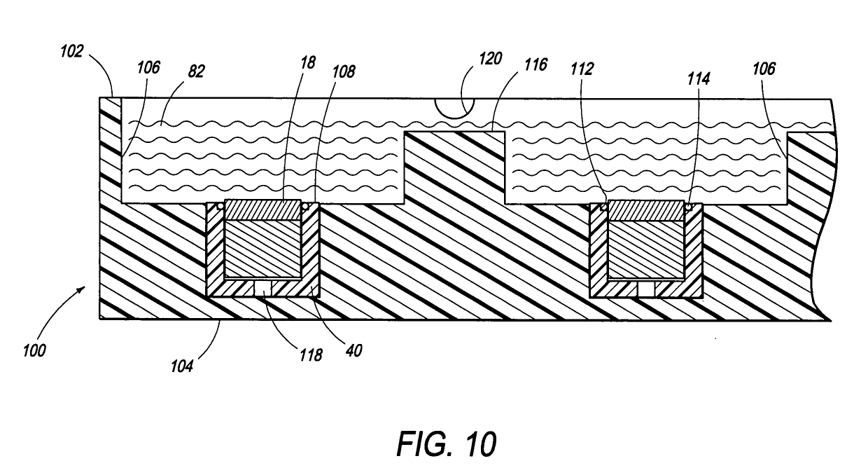

FIG. 10 illustrates an alternative tray configuration in which sockets 110 are large enough to receive fixtures 40, and PDC 10 is placed in fixture 40, which is then located in socket 110.

### OPERATION OF THE INVENTION

The present invention relates to a method of leaching a portion or all of the binder-catalyst of a PDC from between the bonded diamond crystals. In the preferred embodiment, a method of sonochemically leaching binder-catalyst material from a polycrystalline structure 14 of a PDC 10 includes the steps of:
a. shielding the portion of the PDC which is not intended to be leached;
b. immersing the shielded PDC in a corrosive solution; and
c. inducing sonic energy at the interface between the PDC and the corrosive solution.

The first step of the sonochemical leaching process is shielding that portion of the PDC 10 in which exposure to corrosive solution 82 is not desired, including at least the substrate portion 12. In a preferred embodiment, PDC 10 is shielded by placing it in fixture 40. Fixture 40 is an acid-resistant material such as graphite or high-density polyethylene (HDPE). Graphite is the more preferred material since it more readily transmits sonic energy than HDPE. Fixture 40 has a hollow cylindrical center 44 for receiving PDC element 10. In the preferred embodiment, an acid-resistant sealant 70, such as grease, is applied to the surface of center 44. As PDC 10 is pressed into center 44, excess sealant escapes through relief 52. Seal 60 is compressed to provide an interference fit against PDC 10. In a preferred embodiment, cutting surface 18 of PDC 10 is coated with a surfactant, such as acetone, prior to immersion.

The second step of the sonochemical leaching process is immersion of shielded PDC 10 in a corrosive solution 82. Fixture 40, with PDC 10 encased and shielded, is placed in an acid-resistant vessel 80, such as a glass beaker. Vessel 80 is then filled with a corrosive solution 82 for the purpose of dissolving the binder-catalyst in diamond wafer 14 of PDC 10. In the preferred embodiment, corrosive solution 82 is an Aqua Regia solution. Aqua Regia is a chemical industry reference for a mixture of concentrated hydrochloric and nitric acids, containing one part by volume of nitric acid (HNO3) to three parts of hydrochloric acid (HCl). It has been proven to be an effective solvent for dissolving cobalt. Other acids are also well known to be effective.

Sealant 70 blocks relief 52 and prevents corrosive solution 82 from attacking substrate portion 12 of PDC 10. Likewise, seal 60 and sealant 70 prevent corrosive solution 82 from attacking those other portions of PDC 10 for which exposure to corrosive solution 82 is not desired. This leaves PDC 10 properly shielded from corrosive solution 82. Cutting surface 18 of PDC 10 is exposed in direct contact with corrosive solution 82.

In another preferred embodiment, cutting surface 18 of PDC 10 is coated with a surfactant prior to immersion. In the preferred embodiment, the surfactant is acetone. The surfactant acts primarily as a cleaning agent.

The third step of the sonochemical leaching process is inducing sonic energy at the interface between PDC 10 and corrosive solution 82. A sonic vessel 90 is provided having sonic transducers attached to provide the sonic energy. In the preferred embodiment, sonic vessel 90 is an ultrasonic vessel, producing a frequency of less than approximately 20 kilohertz. A stand 92 may be provided within sonic vessel 90. Sonic vessel 90 is partially filled with inert liquid 94, such as water. Beaker 80 containing corrosive solution 82, fixture 40, and PDC 10, is located on stand 92 and the sonic vessel is energized. In the preferred embodiment, ultrasonic energy is thus transmitted to the interface between cutting face 18 and corrosive solution 82.

The sonic energy agitates the interface and greatly accelerates the dissolution rate of the binder-catalyst in corrosive solution 82. This is achieved, in part, by displacing static aeration associated with dissolution of the binder-catalyst at cutting surface 18 and within the polycrystalline diamond structure as leaching progresses. This provides a significant advantage over prior-art methods of leaching binder-catalyst from PDC 10 elements that rely on a chemical process in which the binder-catalyst is slowly dissolved by an acidic reagent in a static bath.

In addition to the accelerated processing rate, the sonochemical process reduces the uncertainty with regards to the depth of the leach into diamond wafer 14. Referring to FIG. 2, a leached PDC 20 is illustrated, now referred to as TSD 20 since it is now thermally stable. It has been determined to be critical to control the depth of the leach achieved for performance reasons. The depth of the leach is seen in FIG. 2. Diamond wafer 24 is divided into two general portions at an interface 30. Binder-catalyst filled portion 32 forms the lower portion, bonded to substrate portion 12. Binder-catalyst leached portion 34, forms the upper portion, adjoined to the filled portion at interface 30. The height of leached portion 34 represents the depth of the leach, providing TSD element 20 with its thermally stable cutting surface 28.

In addition to controlling the depth of leach, the disclosed sonochemical process provides a more uniform transitional interface 30 between filled portion 32 and leached portion 34. This uniformity represents a reduction in the quantity and size of stress-risers that may be generated at interface 30 and which can lead to premature failure of PDC 10.

A tray 100 is disclosed as part of a system for efficiently sonochemical leaching a plurality of PDC 10 elements together. Tray 100 has a plurality of spaced-apart reservoirs 106 which are substantially isolated from each other. Isolation of reservoirs 106 enables sonochemical leaching with a predetermined volumetric exposure to corrosive solution 82. By utilizing a metered amount of corrosive solution 82, the leaching process is further controlled, and results are improved. This helps to resolve important process issues which add uncertainty to results related to sonic decomposition of corrosive solution 82, and dilution and pH reduction of corrosive solution 82 as the binder-catalyst dissolves.

In an optional embodiment, equalizing channels 116 interconnect reservoirs 106 to equalize the volume of corrosive solution 82 between reservoirs 106. In a related embodiment, overflow channels 120 provide a limit to the volume of corrosive solution 82 in each reservoir 106. Overflow channels 120 may be directed to an overflow reservoir 122.

In addition to the increased process control that isolated and volume controlled exposure provides, the quantity of hazardous waste generated by the process is reduced.

It will be readily apparent to those skilled in the art that the general principles defined herein may be applied to other embodiments and applications without departing from the spirit and scope of the present invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

I claim:

1. A method of sonochemically leaching binder-catalyst material from a polycrystalline structure of a PDC, including the steps of:
shielding a portion of the PDC to prevent leaching;
immersing the shielded PDC in corrosive solution; and
inducing sonic energy into the corrosive solution.

2. The method of claim 1, wherein the corrosive solution is substantially isolated from other PDCs.

3. The method of claim 1, wherein the step of shielding the PDC further comprises:
placing the PDC into a shielding fixture.

4. The method of claim 3, wherein the step of shielding the PDC further comprises:
applying an acid-resistant sealant between the shielding fixture interior and the PDC.

5. The method of claim 1, wherein the corrosive solution is Aqua Regia.

6. The method of claim 1, wherein the sonic energy is ultrasonic, having a frequency of less than approximately 20 kilohertz.

7. The method of claim 1, further comprising the step of:
applying a surfactant to the cutting surface of the PDC prior to immersing it.

8. The method of claim 7, wherein the surfactant is acetone.

9. A shielding fixture for use in sonochemical leaching binder-catalyst material from a PDC, comprising:
an acid-resistant body having a hollow cylindrical center for receiving the PDC element;
a top side having a counterbore for receiving an acid-resistant O-ring; and
a bottom side having a relief.

10. The fixture of claim 9, wherein the fixture is made of graphite.

11. The fixture of claim 9, wherein the fixture is made of high-density polyethylene.

12. A shielding fixture for use in sonochemical leaching binder-catalyst material from a PDC, comprising:
an acid-resistant body having a hollow cylindrical center for receiving the PDC element;
a bottom side having a relief; and
wherein the PDC is located in the center of the body in interference fit.

13. A tray for use in sonochemical leaching binder-catalyst material from a PDC, comprising:
an acid-resistant tray body having a top and an opposite bottom;
a plurality of isolated reservoirs located on the top;
a socket for receiving a PDC located at the bottom of each reservoir;
a counterbore for receiving an acid-resistant O-ring located in the socket adjacent to the reservoir; and
a relief extending between the bottom of the tray and the socket.

14. The tray of claim 13, further comprising;
a plurality of overflow channels limiting the volumetric capacity of the reservoirs.

15. The tray of claim 13, further comprising;
a plurality of equalizing channels interconnecting the reservoirs.

16. The tray of claim 13, wherein the tray is made of graphite.

17. The tray of claim 13, wherein the tray is made of high-density polyethylene.

18. A system for sonochemical leaching binder-catalyst material from a plurality of PDCs, comprising:
a sonic vessel having sonic transducers operatively attached;
an acid-resistant tray having a top and a bottom;
the tray bottom locatable within the sonic vessel;
a plurality of isolated reservoirs formed in the tray;
a socket formed at the bottom of the reservoirs; and
wherein PDCs to be leached are locatable within a socket.

19. The system of claim 18, wherein the sonic energy transducer is an ultrasonic transducer, generating electromagnetic energy in a frequency of less than approximately 20 kilohertz.

20. The system of claim 18, wherein the sonic vessel contains an inert solution.

21. The system of claim 18, wherein the reservoirs are filled with a corrosive solution.

22. The system of claim 21, wherein the corrosive solution is Aqua Regia.

23. The system of claim 18, further comprising:
a countersink extending from the top of the tray to the socket;
an acid-resistant seal located in the countersink; and
wherein PDCs to be leached are locatable within the sockets in interference fit with the seal.

24. The system of claim 18, further comprising:
a relief extending from the bottom of the tray to the socket.

25. The system of claim 18, further comprising:
an acid-resistant sealant applied between the socket and the PDC.
